(19) United States
(12) Patent Application Publication
(10) Pub. No.: US 2020/0027003 A1
(43) Pub. Date: Jan. 23, 2020

(54) PACKAGE METHOD OF RADIOACTIVE DISMANTLED PARTS

(71) Applicant: Institute of Nuclear Energy Research, Atomic Energy Council, Executive Yuan, Taoyuan City (TW)

(72) Inventors: HUANG-JAU WU, TAOYUAN CITY (TW); CHUNG-HAO HUANG, TAOYUAN CITY (TW); FENG-CHENG YANG, TAIPEI CITY (TW)

(21) Appl. No.: 16/394,340

(22) Filed: Apr. 25, 2019

(30) Foreign Application Priority Data
Jul. 19, 2018 (TW) 107124937
Dec. 3, 2018 (TW) 107143284

(51) Int. Cl. G06N 3/12; G06T 17/00; G06F 17/50; G06Q 50/28

(52) U.S. Cl. CPC G06N 3/126; G06T 17/00; B65D 85/70; G06Q 50/28; G06F 17/5009

(57) ABSTRACT

A packaging methodology for radioactive dismantled parts of nuclear facilities is provided. This methodology integrates voxelization and metaheuristic to discretize the irregular 3D shape of various dismantled parts and put them into the containers with greatest efficiency. To enumerate the possible locations and orientations of an irregular part effectively, the solid models of the dismantled parts are descripted to user-specified voxelization operations. Therefore, discretized parts and container yield a finite space of optimal solutions and make the evolution algorithm viable for optimization quest. This methodology improves the package efficiency of the radioactive dismantled parts to reduce the required quantity of the storage containers.

### CROSS-REFERENCE TO RELATED APPLICATION

This application claims priority from Taiwan Applications No. 107124937 and No. 107143284, respectively filed on Jul. 19, 2018 and Dec. 3, 2018, in the Taiwan Intellectual Property Office, the content of which is hereby incorporated by reference in its entirety for all purposes.

### BACKGROUND OF THE INVENTION

### Field of the Invention

The present invention relates to a package method of radioactive dismantled parts. The method optimizes the packaging configuration of the dismantled parts by making use of voxel models and heuristic genetic algorithm to minimize the number of the used packaging boxes.

### Description of the Related Art

Nuclear power plants are a significant source of national electrical supply. Since nuclear power plants do not cause air pollution or produce greenhouse gases such as CO₂, nuclear power plants play an important role in supplying energy. However, nuclear disaster occurred in the 2011 Tohoku earthquake raised doubts about the safety of nuclear power generation and hence leads society to face the decommissioning issue of the nuclear power plants.

The dismantled parts of radioactive waste have to be loaded into packaging boxes for further processing in the process of decommissioning the nuclear power plants. Since each packaging box has its limitations on the size and dose rate, it is necessary to optimize the packaging configuration of the dismantled parts to minimize the number of the used packaging boxes. However, there are no optimal package methods available for the dismantled parts of radioactive waste. Therefore, the inventor of the present invention intends to design an algorithm for packaging dismantled parts to improve the drawbacks of prior art for packaging dismantled parts having irregular shapes so as to enhance industrial use.

### SUMMARY OF THE INVENTION

In view of the aforementioned issues of prior art, the present invention provides an optimized packaging algorithm for the dismantled parts having irregular shapes according to the 3D voxelization and the heuristic genetic algorithm. The simple rectangular object packaging algorithm in the past has been abandoned, so that the algorithm results are more in line with the actual needs of the industry. The object of the present invention is to provide a packaging method of radioactive dismantled parts to solve the aforementioned issues.

In accordance with one objective of the present invention, a method of packaging radioactive dismantled parts is disclosed. The method includes: (1) flipping each dismantled part according to the coordinate of the dismantled parts and a packaging condition to produce a bounding body of each dismantled part. (2) voxelizing each bounding body, proceeding discretization of each bounding body into a plurality of cubes, and proceeding a Boolean algebra process on each cube and the corresponding dismantled parts such that each cube is divided into a plurality of first cubes and a plurality of second cubes. (3) proceeding an analysis of the plurality of first cubes and the plurality of second cubes of each of the bounding bodies along an analysis axis such that each of the first cubes and the second cubes has a voxel-line-bunch on each analysis position. (4) combining each voxel-line-bunch of each of the bounding bodies as a voxel model such that each dismantled part respectively corresponds to the voxel model to which each dismantled part belongs, wherein each voxel model has position coordinates and orientation codes. (5) coding each dismantled part such that each dismantled part has a permutation number, and deciding the number of packaging boxes for loading the dismantled parts according to the permutation number. (6) calculating packaging data of each dismantled part contained in each packaging box by a genetic algorithm, comprising: (i) setting each permutation number as a first corresponding section of a coding chromosome and each first corresponding section respectively having a corresponding permutation number; computing a first adaptation value of each coding chromosome according to the loading capacity, weight and dose rate of each packaging box. (ii) mating and mutating each coding chromosome to obtain a plurality of varying coding chromosomes, computing a first varying adaptation value of each varying coding chromosome, arranging each first adaptation value and each first varying adaptation value in order, and selecting a plurality of first superior chromosomes according to a first selecting condition. (iii) setting each voxel model corresponding to each first superior chromosome as a second corresponding section of a position chromosome and each second corresponding section respectively having a corresponding voxel model; computing a second adaptation value of each position chromosome according to the position coordinates and the orientation codes of each voxel model. (iv) mating and mutating each position chromosome to obtain a plurality of varying position chromosomes, computing a second varying adaptation value of each varying position chromosome, arranging each second adaptation value and each second varying adaptation value in order, and selecting a plurality of second superior chromosomes according to a second selecting condition. (v) integrating the position coordinate, the orientation code and the permutation number corresponding to each second superior chromosome as the packaging data; and (7) loading each dismantled part into the packaging box, to which each dismantled part belongs, according to the packaging data corresponding to each packaging box. Through the voxel model in coordination with the genetic algorithm, the packaging of the dismantled parts is optimized. The dismantled parts are loaded into the corresponding packaging boxes according to the packaging data to minimize the number of the used packaging boxes.

Preferably, the Boolean algebra process is an intersection set operation, each of the first cubes corresponds to the dismantled part to which each of the first cubes belongs and has a solid core, and each of the second cubes does not correspond to the dismantled part to which each of the second cubes belongs and has an air core.

Preferably, the packaging condition is that adjacent surfaces of different dismantled parts are orthogonal, that is, adjacent surfaces of different dismantled parts are perpendicular to each other.

Preferably, the first selecting condition is that the coding chromosomes and the varying coding chromosomes corresponding to the first few values of the plurality of first adaptation values and the first varying adaptation values which have smaller numerical values when arranged according to the numerical values are the plurality of first superior chromosomes, and the number of the plurality of first superior chromosomes is equal to the number of the coding chromosomes.

Preferably, the second selecting condition is that the position chromosomes and the varying position chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the position chromosomes.

In accordance with one objective of the present invention, a method of packaging radioactive dismantled parts is disclosed. The method includes: (1) flipping each dismantled part according to the coordinate of the dismantled parts and a packaging condition to produce a bounding body of each dismantled part. (2) voxelizing each bounding body, proceeding discretization of each bounding body into a plurality of cubes, and proceeding the Boolean algebra process on each cube and the dismantled part corresponding to each cube such that each cube is divided into a plurality of first cubes and a plurality of second cubes. (3) proceeding an analysis of the plurality of first cubes and the plurality of second cubes of each of the bounding bodies along an analysis axis such that each of the first cubes and the second cubes has a voxel-line-bunch on each analysis position. (4) combining each voxel-line-bunch of each of the bounding bodies as a voxel model such that each dismantled part respectively corresponds to the voxel model to which each dismantled part belongs, wherein each voxel model has the position coordinates and the orientation codes. (5) coding each dismantled part such that each dismantled part has a permutation number, and deciding the number of packaging boxes for loading the dismantled parts according to the permutation number. (6) calculating permutation data of each dismantled part, on which the discretization has been proceeded, contained in each packaging box by a genetic algorithm, comprising: (i) setting each permutation number as a first corresponding section of a coding chromosome and each first corresponding section respectively having a corresponding permutation number; computing a first adaptation value of each coding chromosome according to the loading capacity, weight and dose rate of each packaging box. (ii) mating and mutating each coding chromosome to obtain a plurality of varying coding chromosomes, computing a first varying adaptation value of each varying coding chromosome, arranging each first adaptation value and each first varying adaptation value in order, and selecting a plurality of first superior chromosomes according to a first selecting condition. (iii) integrating the permutation number corresponding to each of the first average superior chromosomes as the permutation data; and (7) calculating weight data of a weight varying value of each packaging box by a genetic algorithm, comprising: (i) setting the weight varying value of each packaging box as a second corresponding section of a weight chromosome, each second corresponding section respectively having a corresponding weight varying value, and computing a second adaptation value of each of the weight chromosomes according to each of the weight varying value. (ii) mating and mutating each of the weight chromosomes to obtain a plurality of vary weight chromosome, computing a second varying adaptation value of each of the varying weight chromosome, arranging each second adaptation value and each second varying adaptation value in order, and selecting a plurality of second superior chromosomes according to a second selecting condition. (iii) integrating the weight varying value corresponding to each second superior chromosome as the weight data; and (8) calculating position data of each dismantled part, on which the discretization has been proceeded, contained in each packaging box by a genetic algorithm, comprising: (i) setting each voxel model as a third corresponding section of a position chromosome and each of the third corresponding sections respectively having a corresponding voxel model, computing a third adaptation value of each position chromosome according to the position coordinates and the orientation codes of each of the voxel modes. (ii) mating and mutating each position chromosome to obtain a plurality of varying position chromosomes, computing a third varying adaptation value of each varying position chromosome, arranging each of the third adaptation values and each of the third varying adaptation values in order, and selecting a plurality of third superior chromosomes according to a third selecting condition. (iii) integrating the position coordinates and the orientation codes corresponding to each of the third superior chromosomes as the position data; and (9) calculating dose rate data of each dismantled part contained in each packaging box by a genetic algorithm, including (i) setting the dose rate of each dismantled part as the fourth corresponding section of the dose-rate chromosomes, wherein each fourth corresponding section has a corresponding dose rate. Further, calculating a fourth adaptation value of each dose-rate chromosome according to the dose rate of each dismantled part. (ii) mating and mutating each dose-rate chromosome to obtain a plurality of varying dose-rate chromosomes, calculating a fourth varying adaptation value of each varying dose-rate chromosome, arranging each fourth adaptation value and each fourth varying adaptation value in order, and choosing a plurality of fourth superior chromosomes according to a fourth selecting condition. (iii) integrating the dose rate of each fourth superior chromosome as the dose rate data. (10) loading each dismantled part, on which the discretization has been proceeded, into the packaging box, to which each dismantled part belongs, according to the permutation data, the weight data, the position data and the dose rate data corresponding to each packaging box. Through the voxel model in coordination with the genetic algorithm, the packaging of the dismantled parts is optimized. The dismantled parts are loaded into the corresponding packaging boxes according to the permutation data, the weight data, the position data and the dose rate data to minimize the number of the used packaging box.

Preferably, the Boolean algebra process is an intersection set operation, each of the first cubes corresponds to the dismantled part to which each of the first cubes belongs and has a solid core, and each of the second cubes does not correspond to the dismantled part to which each of the second cubes belongs and has an air core.

Preferably, the packaging condition is that adjacent surfaces of different dismantled parts are orthogonal, that is, adjacent surfaces of different dismantled parts are perpendicular to each other.

Preferably, the first selecting condition is that the coding chromosomes and the varying coding chromosomes corresponding to the first few values of the plurality of first adaptation values, the first varying adaptation values and the first average adaptation value which have smaller numerical values when arranged according to the numerical values are the plurality of first average superior chromosomes, and the number of the plurality of first average superior chromosomes is equal to the number of the coding chromosomes.

Preferably, the second selecting condition is that the weight chromosomes and the varying weight chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the weight chromosomes.

According to the above description, the method of packaging dismantled parts disclosed in the present application is that the packaging of the dismantled parts is optimized through the voxel model in coordination with the genetic algorithm, and the dismantled parts are loaded into the corresponding packaging boxes so as to average the weight loaded into each packaging box and to minimize the number of the used packaging boxes.

### BRIEF DESCRIPTION OF THE DRAWINGS

FIG. 1 illustrates the block diagram of the first embodiment of the radioactive dismantled part packaging method of the invention.

FIG. 2 illustrates the flow chart of the first embodiment of the radioactive dismantled part packaging method of the invention.

FIG. 3 illustrates the bounding body of the first embodiment of the radioactive dismantled part packaging method of the invention.

FIG. 4 illustrates the voxel model of the first embodiment of the radioactive dismantled part packaging method of the invention.

FIG. 5 illustrates the flow chart of the genetic algorithm of the first embodiment of the radioactive dismantled part packaging method of the invention.

FIG. 6 illustrates the flow chart of the genetic algorithm of the first embodiment of the radioactive dismantled part packaging method of the invention.

FIG. 7 illustrates the flow chart of the second embodiment of the radioactive dismantled part packaging method of the invention.

FIG. 8 illustrates the flow chart of the genetic algorithm of the second embodiment of the radioactive dismantled part packaging method of the invention.

FIG. 9 illustrates the flow chart of the genetic algorithm of the second embodiment of the radioactive dismantled part packaging method of the invention.

FIG. 10 illustrates the flow chart of the genetic algorithm of the second embodiment of the radioactive dismantled part packaging method of the invention.

FIG. 11 illustrates the flow chart of the genetic algorithm of the second embodiment of the radioactive dismantled part packaging method of the invention.

### DETAILED DESCRIPTION OF THE PREFERRED EMBODIMENTS

In order to provide understanding of the technical features, the content, the advantages and the achievable performance of the present invention, the present invention are presented through embodiments described below in detail in accordance with the accompanying drawings. The accompanying drawings are intended to illustrate and assist the specification and do not present the actual ratio and the precise configuration. Consequently, the ratio and the configuration relationship in the accompanying drawings should not be interpreted to limit the scope of claims of the present invention.

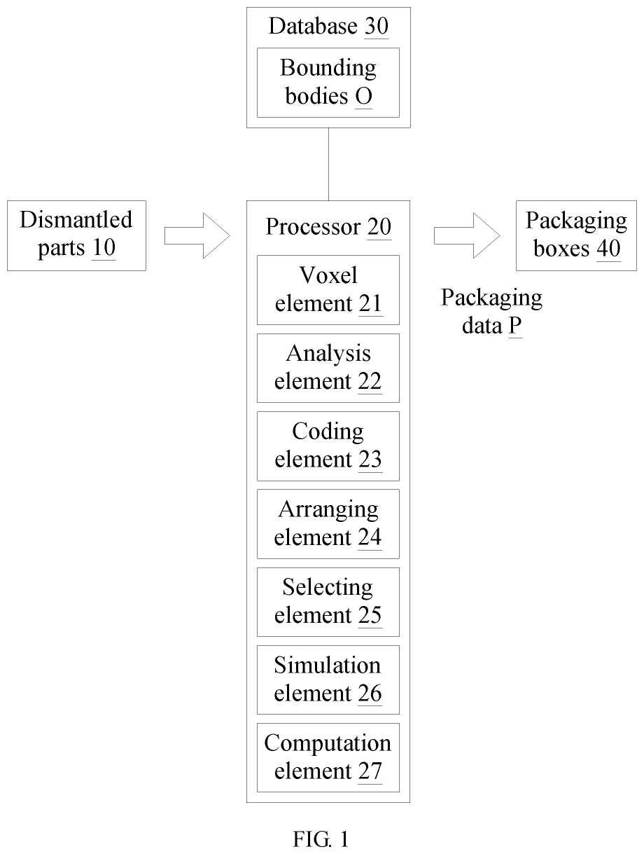

Referring to FIG. 1, which illustrates the block diagram of the first embodiment of the radioactive dismantled part packaging method of the invention. As shown in FIG. 1, the devices needed in the method of packaging dismantled nuclear reactor parts of the invention include the dismantled part 10, the processor 20, the database 30 and the packaging box 40. The database 30 has various kinds of the bounding bodies O, the processor 20 selects a suitable bounding body O from the database 30 according to the structure and shape of the inputted dismantled part 10, and the processor 20 includes the voxel element 21, the analysis element 22, the coding element 23, the arranging element 24, the selecting element 25 and the simulation element 26. The aforementioned devices are needed for the calculation of the genetic algorithm. The calculation of the genetic algorithm is described hereinafter. The processor 20 outputs the packaging data P after the calculation of the genetic algorithm.

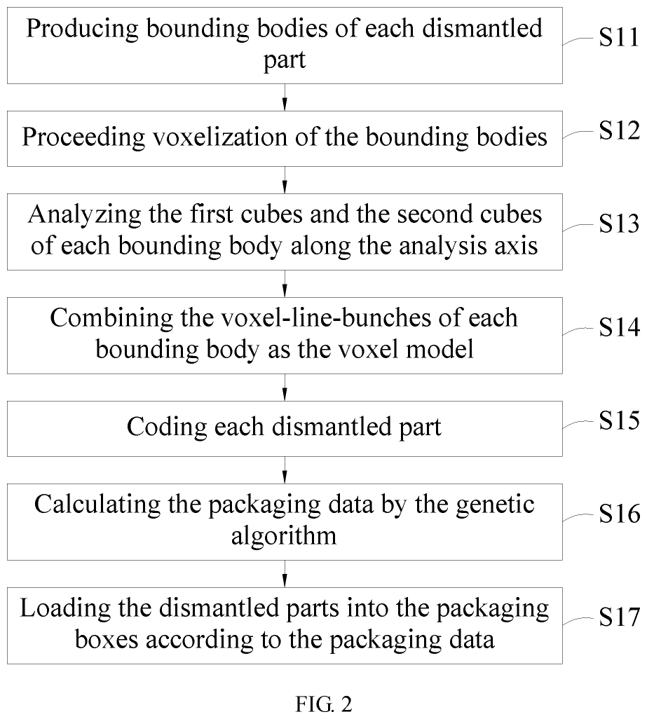

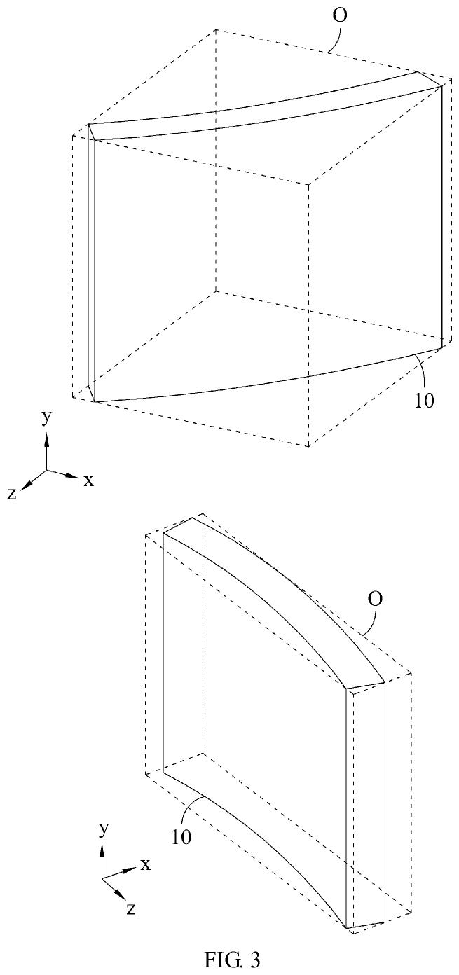

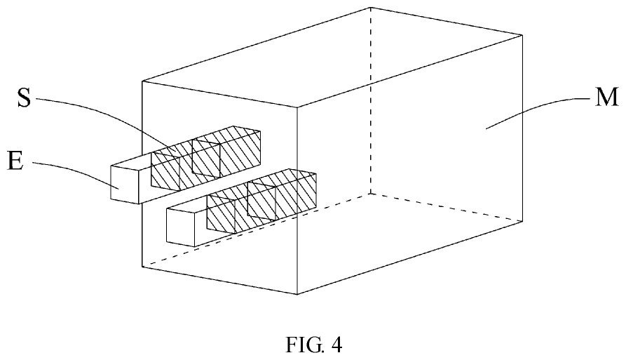

Referring to FIGS. 2-4, which respectively illustrate the flow chart, the bounding body and the voxel model of the first embodiment of the radioactive dismantled part packaging method of the invention. In the embodiment, the dismantled part packaging method of the invention includes: (1) Step S11: the processor 20, as shown in FIG. 3, flips each dismantled part 10 until each dismantled part 10 is located with a proper orientation according to the coordinate of the dismantled parts 10 and a packaging condition. The processor 20 then produces the bounding body O of each dismantled part 10. Each of the bounding bodies O entirely packs the dismantled parts for the sequential structure analysis of each dismantled part 10. Note that the volume of each bounding body O is set to be larger than that of each dismantled part 10, and the volume of the plurality of bounding bodies O is set to be larger than the plurality of dismantled parts 10. The volume of each bounding body O may surely be smaller than that of each dismantled part 10, which is suitable when the dismantled part 10 has an irregular shape. In this case, the dismantled part 10 is just partially packaged by the bounding body O such that the distribution result of each dismantled part is not optimal. Each of the bounding bodies 10 is configured to ensure that the dismantled parts 10 do not interfere with each other when packed in the packaging boxes 40 and confirm the packaging status of each of the bounding bodies O and the space occupied by each dismantled part in coordination with the coordinates. It should be noted that the bounding body O may be a rectangular body, as shown in FIG. 3, and should be a cylindrical body or a polyhedron of other kinds according to the shape of the dismantled part 10 as well. The packaging condition of the dismantled part packaging method of the invention is that adjacent surfaces of different dismantled parts 10 are orthogonal, that is, adjacent surfaces of different dismantled parts 10 are perpendicular to each other. (2) Step S12: the voxel element 21 proceeds voxelization of each of the bounding bodies O to proceed discretization of each bounding body O to generate a plurality of cubes, and proceeds the Boolean algebra process on each cube and the dismantled part 10 corresponding to each cube. The voxel element 21 divides each cube into a plurality of first cubes S and a plurality of second cubes E, as shown in FIG. 4. Specifically, the voxel element 21 proceeds an intersection set operation on each cube and the dismantled part 10 corresponding to each cube so as to divide each cube into a plurality of first cubes S and a plurality of second cubes E, as shown in FIG. 4. Each of the first cubes S corresponds to the dismantled part 10 to which each of the first cubes S belongs and has a solid core, and each of the second cubes E does not corresponding to the dismantled part 10 to which each of the second cubes E belongs and has an air core, that is, each of the first cubes S actually exists in the dismantled parts 10 while each of the second cubes E does not exist in the dismantled parts 10. (3) Step S13: the analysis element 22 proceeds an analysis of the plurality of first cubes S and the plurality of second cubes E of each of the bounding bodies O along a analysis axis such that each of the first cubes S and the second cubes E has a voxel-line-bunch on each analysis position, as shown in FIG. 4. Specifically, each of the first cubes S and the second cubes E connects to each other to form voxel lines, the voxel lines constitute voxel sections and the voxel sections on each analysis position constitute voxel-line-bunches. (4) Step S14: the voxel element 21 combines each voxel-line-bunch of each of the bounding bodies O as a voxel model M such that each dismantled part 10 respectively corresponds to the voxel model M to which each dismantled part 10 belongs, wherein each voxel model M has the position coordinates and the orientation codes. The voxel model M is obtained according to the model of the voxel-line-bunch in coordination with the coordinates and there are 24 types of the voxel-line-bunches. (5) Step S15: the coding element 23 codes each dismantled part 10 such that each dismantled part 10 has a permutation number. The number of packaging boxes 40 is decided according to the permutation number, and each packaging box 40 contains the dismantled parts 10. It should be noted that the remaining dismantled parts 10 will be loaded into other packaging boxes 40 when the present packaging box 40 cannot contain additional dismantled parts 10 due to exceeding weight, volume or dose rate. Besides, each packaging box 40 contains a plurality of dismantled parts 10 rather than a single dismantled part 10, wherein a weight limitation equation is presented as: Σwᵢ<w̅, wᵢ represents the weight of a single dismantled part 10, and W̅ represents the weight capacity of a packaging box 40; a volume limitation equation is presented as Σvᵢ<V̅, vᵢ represents the volume of a single dismantled part 10, and V̅ represents the volume capacity of a packaging box 40 (6) Step S16: the processor 20 calculating packaging data P of each dismantled part 10 contained in each packaging box 40 by a genetic algorithm, wherein the genetic algorithm will be described later. (7) Step S17: loading each dismantled part 10 into the packaging box 40 corresponding to each dismantled part 10 according to the packaging data P corresponding to each packaging box 40. Through the voxel model M in coordination with the genetic algorithm, the packaging of the dismantled parts 10 is optimized. The dismantled parts 10 are loaded into the corresponding packaging boxes 40 according to the packaging data P to minimize the number of the used packaging boxes 40.

Here, it should be noted that the dismantled parts 10 come from a dismantled nuclear reactor. The plurality of first cubes S and the plurality of second cubes E are voxels (a voxel is the smallest unit of the 3-dimension space segmentation). The process of voxelization and the establishment of the voxel model M are based on the voxel-line-bunched representation (VLB-rep), and the voxel-line-bunched representation includes the VoxelLine structure, the VLBOrientation and the VoxelLineBunchedSolid. The process of voxelization is executed in the SolidWorks, and the database 30 is the database of the SolidWorks. Since the data of the x-axis needed to be computed is less than that of the y-axis and the z-axis, the analysis axis is recommended to be the x-axis and the analysis position can be modified according to the actual number of the voxel-line-bunches.

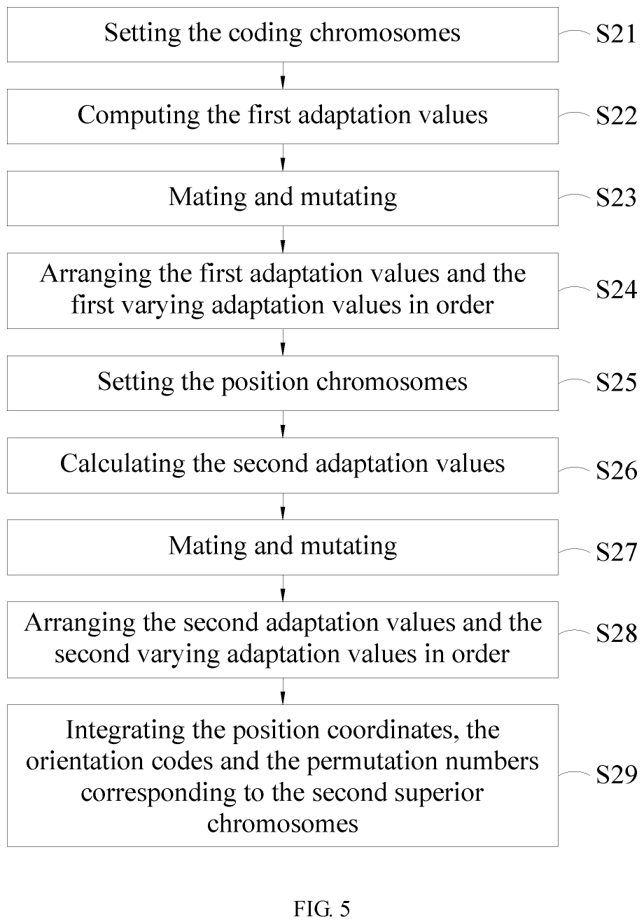

Referring to FIG. 5, which illustrates the flow chart of the genetic algorithm of the first embodiment of the radioactive dismantled part packaging method of the invention. As shown in FIG. 5, the processor 20 calculates the packaging data P by a genetic algorithm with the following steps: (i) Step S21: the simulation element 26 sets each permutation number as a first corresponding section of a coding chromosome and each first corresponding section respectively having a corresponding permutation number. For instance, according to the number of each coding chromosome, the permutation numbers may be set as d=[d₁ d₂ . . . dᵢ], dᵢ∈{1, 2, . . . , n}, wherein dᵢ represents each chromosome. (ii) Step S22:

the computation element 27 computes a first adaptation value of each coding chromosome according to the loading capacity, weight and the dose rate limitation of each packaging box 40. (iii) Step S23: the simulation element 26 mates and mutates each coding chromosome to obtain a plurality of varying coding chromosomes and the computation element 27 computes a first varying adaptation value of each varying coding chromosome, wherein the permutation numbers corresponding to the plurality of varying coding chromosomes are different from that corresponding to the plurality of coding chromosomes. (iv) Step S24: the arranging element 24 arranges each first adaptation value and each first varying adaptation value in order, and the selecting element 25 selects a plurality of first superior chromosomes according to a first selecting condition. (v) Step S25: the simulation element 26 sets each voxel model M corresponding to each first superior chromosome as a second corresponding section of a position chromosome and each second corresponding section respectively having a corresponding voxel model M. (vi) Step S26: the computation element 27 computes a second adaptation value of each position chromosome according to the position coordinates and the orientation codes of each voxel model M. For instance, the position coordinates and the orientation codes of each voxel model M may be presented as:

a=[x1y1z1o1x2y2z2o2 . . . xiyizioi],(xi,yi,zi)∈{1,2, . . . ,n},0≤xi<x̅_{B}, 0≤yi<y̅_{B}, 0≤zi<z̅_{B}, 0≤oi<24,

wherein “a” represents the chromosome, (xi, yi, zi) represents the position coordinates of each voxel model M, “oi” represents the orientation codes of each voxel model M, x̅_{B}, y̅_{B}, z̅_{B} respectively represent the voxel of each packaging box 40 on the x-axis, the y-axis and the z-axis, the voxel capacity of each packaging box 40 is L̅=x̅_{B}*y̅_{B}*z̅_{B}, and the voxel capacity of the voxel model M of all dismantled parts 10 is smaller than that of each packaging box 40. (vii) Step S27: the simulation element 26 mates and mutates each position chromosome to obtain a plurality of varying position chromosomes and the computation element 27 computes a second varying adaptation value of each varying position chromosome, wherein the position coordinates and the orientation codes corresponding to the plurality of varying position chromosomes are different from that of the plurality of position chromosomes. (viii) Step S28: the arranging element 24 arranges each second adaptation value and each second varying adaptation value in order, and the selecting element 25 selects a plurality of second superior chromosomes according to a second selecting condition. (ix) Step S29: the selecting element 25 integrates the position coordinate, the orientation code and the permutation number corresponding to each second superior chromosome as the packaging data P. Through the sieving mechanism for the permutation numbers, the position coordinates and the orientation codes of the genetic algorithm and the permutation of the adaptation values according to the numerical values thereof for reducing the computation complexity and the number of the used packaging boxes 40, the dismantled parts 10 are properly loaded in the packaging boxes 40. Besides, the dismantled parts 10 are prevented from exceeding the packaging box 40 and interfering with each other.

The first selecting condition is that the coding chromosomes and the varying coding chromosomes corresponding to the first few values of the plurality of first adaptation values and the first varying adaptation values which have smaller numerical values when arranged according to the numerical values are the plurality of first superior chromosomes, and the number of the plurality of first superior chromosomes is equal to the number of the coding chromosomes. When the selecting element 25 cannot find better first superior chromosomes, the evolution of the coding chromosomes proceeds until the 800^{th} generation and stops then. The second selecting condition is that the position chromosomes and the varying position chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the position chromosomes. When the selecting element 25 cannot find better second superior chromosomes, the evolution of the position chromosomes proceeds until the 800^{th} generation and stops then.

In addition, mating and mutating each coding chromosome manufactures the plurality of varying coding chromosomes. Each varying coding chromosome has the permutation number different from the permutation number of each coding chromosome so as to achieve variety of the permutation numbers. Similarly, mating and mutating the position chromosomes manufactures the plurality of the position varying chromosomes. Each varying position chromosome has the position coordinates and the orientation codes different from that of the position chromosomes so as to achieve variety of the position coordinates and the orientation codes.

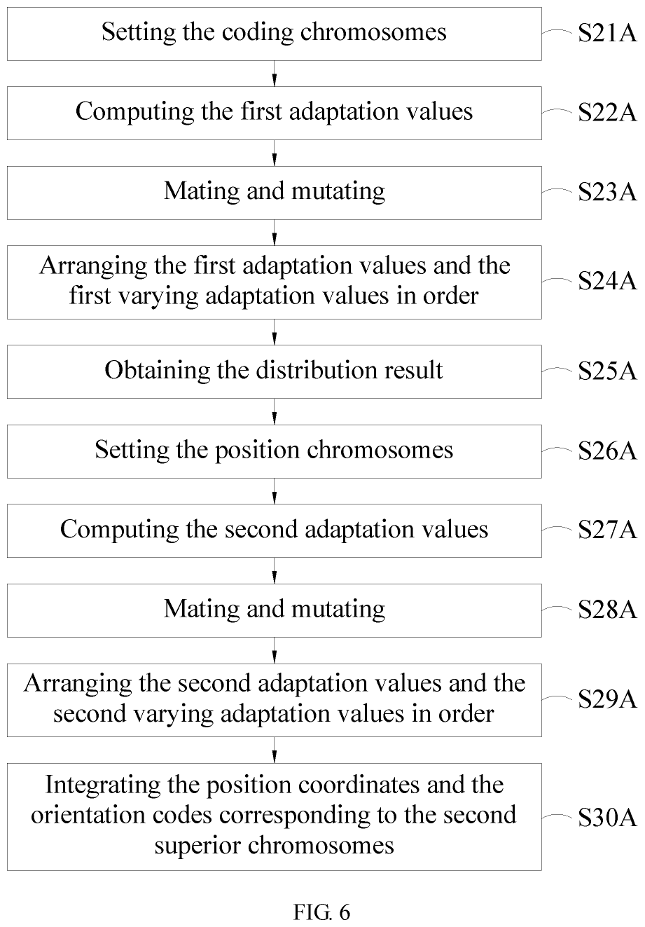

Referring to FIG. 6, which illustrates another flow chart of the genetic algorithm of the first embodiment of the radioactive dismantled part packaging method of the invention. As shown in FIG. 6, which is different from the above description and contains two calculation of the algorithm as the following steps: (i) Step S21A: the simulation element 26 sets each permutation number as a first corresponding section of a coding chromosome and each first corresponding section respectively having a corresponding permutation number. For instance, according to the number of each coding chromosome, the permutation numbers may be set as d=[d₁d₂ . . . dᵢ], dᵢ∈{1, 2, . . . , n}, wherein dᵢ represents each chromosome. (ii) Step S22A: the computation element 27 computes a first adaptation value of each coding chromosome according to the loading capacity, weight and the dose rate limitation of each packaging box 40. (iii) Step S23A: the simulation element 26 mates and mutates each coding chromosome to obtain a plurality of varying coding chromosomes and the computation element 27 computes a first varying adaptation value of each varying coding chromosome, wherein the permutation numbers corresponding to the plurality of varying coding chromosomes are different from the permutation numbers corresponding to the plurality of the coding chromosomes. (iv) Step S24A: the arranging element 24 arranges each first adaptation value and each first varying adaptation value in order and the selecting element 25 selects a plurality of first superior chromosomes according to a first selecting condition, wherein Steps S21A-S25A may be repeated multiple times for better packaging result (v) Step S25A: the selecting element 25 takes the permutation number corresponding to each first superior chromosome and concludes the permutation number of each dismantled part 10 as a binning result. (vi) Step S26A: according to the binning result, setting the voxel model M of each dismantled part 10 contained in the packaging boxes 40 as a second corresponding section of a position chromosome and each second corresponding section respectively having a corresponding voxel model M, wherein the position chromosome is set according to each dismantled part 10 contained in a single packaging box 40. (vii) Step S27A: the computation element 27 computes a second adaptation value of each position chromosome according to the position coordinates and the orientation codes of each voxel model M. For instance, the position coordinates and the orientation codes of each voxel model M may be presented as:

a^{k}=[x1y1z1o1x2y2z2o2 . . . xiyizioi],(xi,yi,zi)∈{1,2, . . . ,n′},0≤xi<x̅_{B}, 0≤yi<y̅_{B}, 0≤zi<z̅_{B}, 0≤oi<24,

wherein “a^{k}” represents the chromosome, (xi, yi, zi) represents the position coordinates of each voxel model M, “oi” represents the orientation codes of each voxel model M, “k” represent the packaging box number of each packaging box 40, the number of the dismantled parts 10 loaded in the k-th packaging box is n′, x̅_{B}, y̅_{B}, z̅_{B} respectively represent the voxel of each packaging box 40 on the x-axis, the y-axis and the z-axis, the voxel capacity of each packaging box 40 is L̅=x̅_{B}*y̅_{B}*z̅_{B}, and the voxel capacity of the voxel model M of all dismantled parts 10 is smaller than that of a single packaging box 40. (viii) Step S28A: the simulation element 26 mates and mutates each position chromosome to obtain a plurality of varying position chromosomes and the computation element 27 computes a second varying adaptation value of each varying position chromosome, wherein the position coordinates and the orientation codes corresponding to the plurality of varying position chromosomes are different from that of the position chromosomes. (ix) Step S29A: the arranging element 24 arranges each second adaptation value and each second varying adaptation value in order and the selecting element 25 selects a plurality of second superior chromosomes according to a second selecting condition. (x) Step S30A: the selecting element 25 integrates the position coordinates and the orientation codes corresponding to each second superior chromosome as a configuration result and each dismantled part 10 of each packaging box 40 is positioned according to the configuration result. Here, the first selecting condition and the second selecting condition are the same as the above description and redundant description is omitted. The present process contains two calculations of the genetic algorithm rather than a single calculation of the genetic algorithm which calculates the permutation numbers, the position coordinates and the orientation codes simultaneously. The present process respectively optimizes the permutation numbers, the position coordinates and the orientation codes to properly load the dismantled parts 10 into each packaging box 40 and minimize the number of the used packaging boxes 40.

Further, according to the desired resolution set by the user, the genetic algorithm of the first embodiment may also dismantle the bounding bodies O and the packaging boxes 40 into resolution elements (similar to voxel) of a fixed number. Further, the dismantled parts are set as rectangular bodies consisting of regular resolution elements. The number of the first cubes S is fixed as well as that of the second cubes E. The resolution elements are used to set the position coordinate of each dismantled part 10 so as to set that the voxels of the dismantled parts 10 is smaller than the voxels of the packaging box 40 to ensure that the dismantled parts 10 do not exceed the packaging box 40. For instance, the position coordinate and the orientation code of each voxel model M may be presented as:

a^{k}=[x1y1z1o1x2y2z2o2 . . . xiyizioi],(xi,yi,zi)∈{1,2, . . . ,n′},0≤xi<x̅′_{B}, 0≤yi<y̅′_{B}, 0≤zi<z̅′_{B}, 0≤oi<24,

wherein “a^{k}” represents the chromosome, (xi, yi, zi) represents the position coordinate of each voxel model M, “oi” represents the orientation code of each voxel model M, “k” represents bonding box number of each packaging box 40, the number of the dismantled parts 10 loaded in the k-th packaging box 40 is n′, x̅_{B}, y̅′_{B}, z̅′_{B} respectively represent resolution element of each packaging box 40 on the x-axis, the y-axis and the z-axis, the resolution element capacity of each packaging box 40 is L̅=x̅_{B}*y̅_{B}*z̅_{B}, and the resolution element capacity of the voxel model M of all dismantled parts 10 is smaller than that of a single packaging box 40.

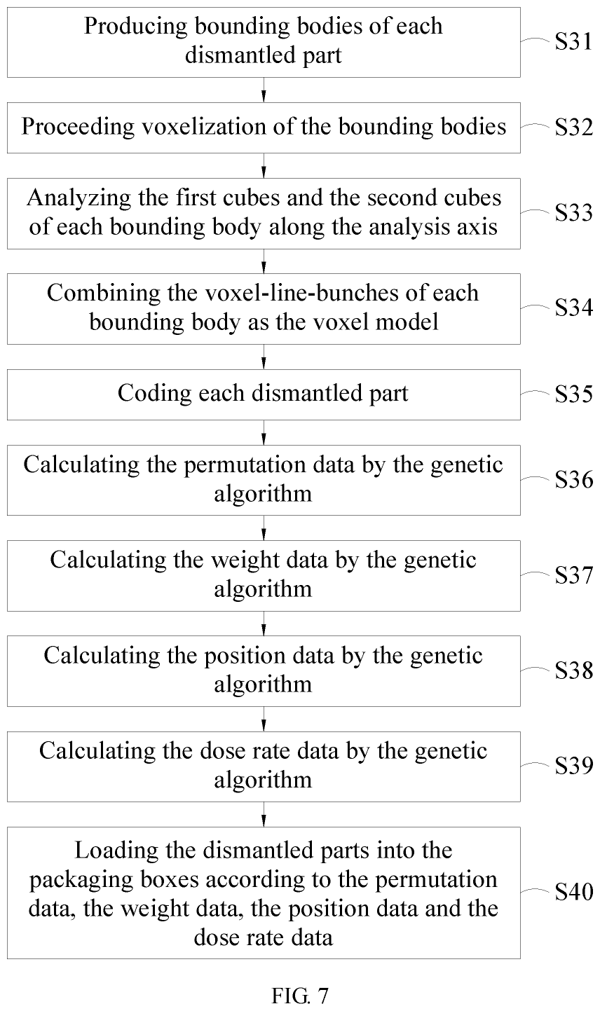

Referring to FIG. 7, which illustrates the flow chart of the second embodiment of the radioactive dismantled part packaging method of the invention. In the embodiment, the method of packaging the dismantled parts with reference to the elements of FIG. 1 includes the following steps: (1) Steps S31-S34 are equivalent to Steps S11-S14, and hence have the same technical features with Steps S11-S14. Therefore, redundant description is omitted. (2) Step S35: the coding element 23 codes each dismantled part 10 such that each dismantled part has a permutation number. The permutation numbers of the dismantled parts 10 decide the number of the packaging boxes 40 and each packaging box 40 contains the dismantled parts 10. It should be noticed that the number of the used packaging boxes 40 is minimized according to the number of the dismantled parts 10, the volume of each packaging box 40, the voxel model of each dismantled part 10 and the weight capacity of each packaging box 40. Besides, each packaging box 40 contains a plurality of dismantled parts 10 rather than a single dismantled part 10. (3) Step S36: the processor 20 calculates permutation data of each dismantled part 10 contained in each packaging box 40 by a genetic algorithm (described later). (4) Step S37: the processor 20 calculates weight data of a weight varying value of each packaging box 40 by a genetic algorithm (described later). (5) Step S38: the processor 20 calculates position data of each dismantled part 10 contained in each packaging box 40 by a genetic algorithm, wherein related description of calculating position data by a genetic algorithm will be discussed later. (6) Step S39: the processor 20 calculates dose rate data of each dismantled part 10 contained in each packaging box 40 by a genetic algorithm, wherein related description of calculating dose rate data by a genetic algorithm will be discussed later. (6) Step S40: loading each dismantled part 10 into the packaging box 40, to which each dismantled part 10 belongs, according to the permutation data, the weight data, the dose rate data and the position data corresponding to each packaging box. Through the voxel model in coordination with the genetic algorithm, the packaging of the dismantled parts 10 is optimized. The dismantled parts 10 are loaded into the corresponding packaging boxes 40 according to the permutation data, the weight data, the dose rate data and the position data to minimize the number of the used packaging box 40.

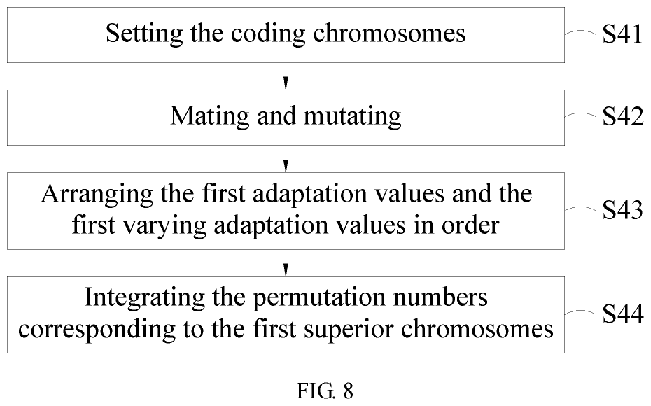

Referring to FIG. 8, which illustrates the flow chart of the genetic algorithm of the second embodiment of the radioactive dismantled part packaging method of the invention. As shown in FIG. 8, the processor 20 calculates permutation data of each dismantled part 10 contained in each packaging box 40 by a genetic algorithm as the following steps: (i) Step S41: the simulation element 26 sets each permutation number as a coding chromosome and computes a first adaptation value of each coding chromosome. (ii) Step S42: the simulation element 26 mates and mutates each coding chromosome to obtain a plurality of varying coding chromosomes and the computation element 27 computes a first varying adaptation value of each varying coding chromosome, wherein permutation numbers corresponding to the plurality of varying coding chromosomes are different from the permutation numbers corresponding to the plurality of coding chromosomes. (iii) Step S43: the arranging element 24 arranges each first adaptation value and each first varying adaptation value in order and the selecting element 25 selects a plurality of first superior chromosomes according to the first selecting condition. (iv) Step S44: the selecting element 25 integrates the permutation numbers corresponding to each first superior chromosome as the permutation data.

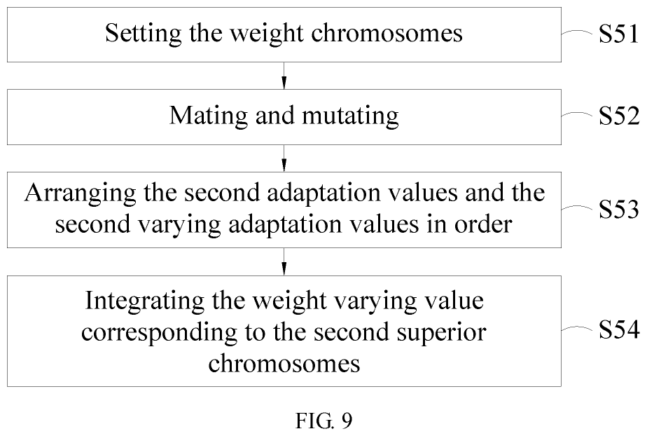

Referring to FIG. 9, which illustrates the flow chart of the genetic algorithm of the second embodiment of the radioactive dismantled part packaging method of the invention. As shown in FIG. 9, following the aforementioned permutation data, the dismantled parts 10 are distributed into the packaging boxes 40 such that each packaging box 40 has weight (for instance, the containers, to which each dismantled part 10 belongs, are numbered as: b=[b₁b₂ . . . bⱼ], bᵢ∈{1, 2, . . . , n}, wherein “bⱼ” represents container number of each container). The processor 20 calculates weight data of a weight varying value of each packaging box 40 by a genetic algorithm as the following steps: (i) Step S51: the simulation element 26 sets the weight varying value of each packaging box 40 as a second corresponding section of a weight chromosome, each second corresponding section respectively having a corresponding weight varying value, and the computation element 27 computes a second adaptation value of each of the weight chromosomes according to each of the weight varying value. (ii) Step S52: the simulation element 26 mates and mutates each of the weight chromosomes to obtain a plurality of vary weight chromosome and the computation element 27 computes a second varying adaptation value of each of the varying weight chromosome, wherein the weight varying values corresponding to the plurality of varying weight chromosomes are different from the weight varying values corresponding to the plurality of weight chromosomes. (iii) Step S53: the arranging element 24 arranges each second adaptation value and each second varying adaptation value in order and the selecting element 25 selects a plurality of second superior chromosomes according to a second selecting condition. (iv) Step S54: the selecting element 25 integrates the weight varying value corresponding to each second superior chromosome as the weight data. Recalculate the genetic algorithm so as to minimize the number of the used packaging boxes 40 and the dismantled parts 10 loaded into the used packaging boxes 40 are evenly distributed.

Here, it should be noticed that the weight of the packaging boxes 40 are averaged and the average weight of the packaging boxes 40 is then obtained. The weight varying value of a specific bounding box 40 is obtained by dividing the square of the difference between the weight of the specific bounding box 40 and the average weight by the total number of the bounding boxes 40. Further, the equation of the second adaptation value related to the weight varying values is presented as: minf(b)=Σₖ₌₁^{S}^{_{c}}(Wₖ−Ŵ)², wherein “wₖ” represents the total weight of the plurality of dismantled parts 10 loaded in a single packaging box 40, Ŵ represents the average weight, “S_{c}” represents the number of the packaging boxes 40 and “minf(b)” represents the second adaptation value. Therefore, the weight varying values of different packaging boxes 40 are different.

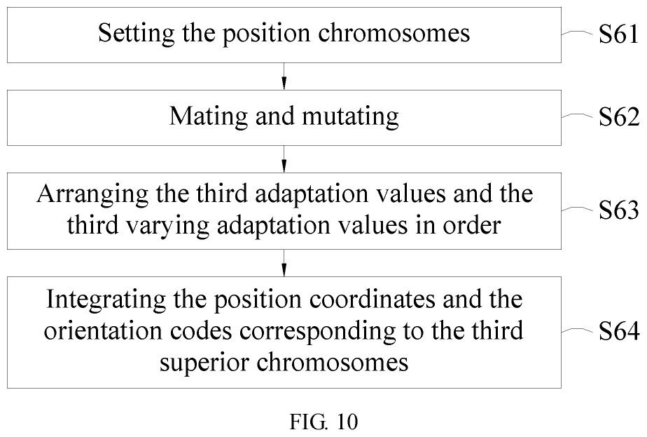

Referring to FIG. 10, which illustrates the flow chart of the genetic algorithm of the second embodiment of the radioactive dismantled part packaging method of the invention. As shown in FIG. 10, following the aforementioned weight data, the dismantled parts 10 are distributed into the packaging boxes 40. The processor 20 calculates position data of each dismantled part 10 contained in each packaging box 40 by a genetic algorithm as the following steps: (i) Step S61: the simulation element 26 sets each voxel model M corresponding to each dismantled part 10 as a third corresponding section of a position chromosome and each of the third corresponding sections respectively having a corresponding voxel model M. The computation element 27 computes a third adaptation value of each position chromosome according to the position coordinates and the orientation codes of each of the voxel modes M. (ii) Step S62: the simulation element 26 mates and mutates each position chromosome to obtain a plurality of varying position chromosomes and the computation element 27 computes a third varying adaptation value of each varying position chromosome, wherein the position coordinates and the orientation codes corresponding to the plurality of varying position chromosomes are different from the position coordinates and the orientation codes of the plurality of position chromosomes. (iii) Step S63: the arranging element 24 arranges each of the third adaptation values and each of the third varying adaptation values in order and the selecting element 25 selects a plurality of third superior chromosomes according to a third selecting condition. (iii) Step S64: the selecting element 25 integrates the position coordinates and the orientation codes corresponding to each of the third superior chromosomes as the position data.

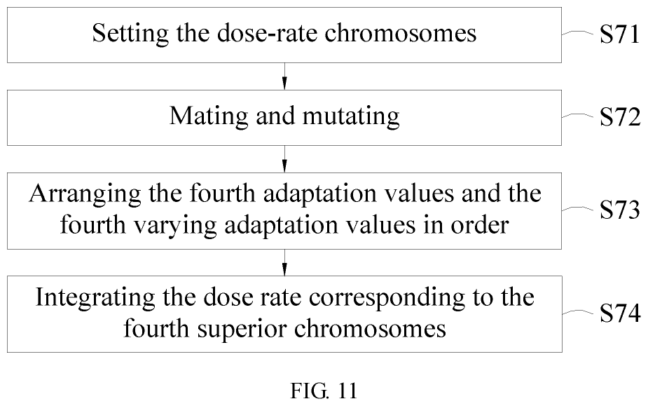

Referring to FIG. 11, which illustrates the flow chart of the genetic algorithm of the second embodiment of the radioactive dismantled part packaging method of the invention. As shown in FIG. 11, according to the weight data being described above, each dismantled part 10 is distributed into the packaging boxes 40 and the processor 20 calculates the dose rate data of each dismantled part 10 loaded in each packaging box 40. The method includes: (i) Step S71: the simulation element 26 sets the dose rate data corresponding to each dismantled part 10 as a fourth corresponding section of a dose-rate chromosome and each of the fourth corresponding sections respectively having a corresponding does rate. The computation element 27 computes a fourth adaptation value of each dose-rate chromosome according to the dose rate of each dismantled part 10. (ii) Step S72: the simulation element 26 mates and mutates each dose-rate chromosome to obtain a plurality of varying dose-rate chromosomes and the computation element 27 computes a fourth varying adaptation value of each varying dose-rate chromosome, wherein the dose rates corresponding to the plurality of varying dose-rate chromosomes are different from the dose rates of the plurality of dose-rate chromosomes. (iii) Step S73: the arranging element 24 arranges each of the fourth adaptation values and each of the fourth varying adaptation values in order and the selecting element 25 selects a plurality of fourth superior chromosomes according to a fourth selecting condition. (iii) Step S74: the selecting element 25 integrates the dose rates corresponding to each of the fourth superior chromosomes as the dose rate data.

It should be noted that, after each dismantled part 10 is loaded into the packaging boxes 40, the dose rate limitation may be specified in consideration of the external surfaces of the bounding box 40 and a specific distance far from the external surfaces of the bounding box 40 so as to determine the loading capacity of each bounding box 40, wherein the dose rate limitation may be determined according to the IAEA (International Atomic Energy Agency) standard. Specifically, one may compute the dose rate on the surface of each dismantled part 10 according to the attenuation coefficient of material of each packaging box 40 and the thickness of the inner layer and the outer layer of each packaging box 40, wherein the material of each packaging box 40 may be set as stainless steel.

Here, the equation and related conditions of the dose rate limitation are described in detail. The specific activity of the dismantled part 10 centers at the center of gravity and is regarded as a radioactive point source. The inspection object of radioactive point source is set to be gamma ray of cobalt-60. The energy level is 1.25 MeV. According to the shielding measures set by the user, calculate the dose rate after the shielding measures are taken. Only the shielding effect of the fillers filling the packaging box 40 with the loaded dismantled parts 10 and the shielding effect of the material of the side walls of the packaging box 40 between the loaded dismantled parts 10 and the inspection point are taken into consideration, wherein the fillers mean concrete or air, which depends on whether or not concrete is used to fill the packaging box 40. The attenuation coefficient of concrete is presented as: μ_{concrete}^{1.25MeV}=0.134, and the attenuation coefficient of air is presented as: μ_{concrete}^{1.25MeV}=0.134. The side walls of the packaging box 40 has the shielding effect, which has the attenuation coefficient of iron as: μ_{Fe}^{1.25MeV}=0.421 Each packaging box 40 is set to be symmetric with respect to the x-axis, y-axis and z-axis. The equation of dose rate limitation is presented as:

$$H = 1153 {I}_{0} exp ( - {\sum }_{i = 1}^{n} {t}_{i} \cdot {μ}_{i}^{( E )} ) = 1153 \times γ \times \frac{A M}{{d}^{2}} \times \frac{0.965}{100} \times exp ( - {\sum }_{i = 1}^{n} {t}_{i} \cdot {μ}_{i}^{( E )} )$$

wherein “A” represents the specific activity (Ci/kg) of unit weight of the material consisting of the dismantled part 10 while the estimated time of cooling is 25 years, “M” represents mass of a single dismantled part, “γ” represents specific Gamma-Ray constant of radiation source Co at energy level E (R*m/Ci*kg), “I₀” represents unshielded Gamma energy rate (Gy/hr) of the radioactive point source without the shielding measures, “tᵢ” represent the thickness of shielding material, “n” represents the number of the shielding materials, μᵢ(E) represents the attenuation factor of shielding material i subject of energy level of radiation source of the fillers, “d” represents the distance between the inspection point and the surface of the packaging box 40 and the inspection point is the point at which the dose rate is measured.

Similarly, the first selecting condition is that the coding chromosomes and the varying coding chromosomes corresponding to the first few values of the plurality of first adaptation values, the first varying adaptation values and the first average adaptation value which have smaller numerical values when arranged according to the numerical values are the plurality of first superior chromosomes, and the number of the plurality of first superior chromosomes is equal to the number of the coding chromosomes. When the selecting element 25 cannot find better first superior chromosomes, the evolution of the coding chromosomes proceeds until the 800^{th} generation and stops then. The second selecting condition is that the weight chromosomes and the varying weight chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the weight chromosomes. When the selecting element 25 cannot find better second superior chromosomes, the evolution of the weight chromosomes proceeds until the 800^{th} generation and stops then. The third selecting condition is that the position chromosomes and the varying position chromosomes corresponding to the first few values of the plurality of third adaptation values and third varying adaptation values which have smaller numerical values when arranged according to the numerical values are the plurality of third superior chromosomes, and the number of the plurality of third superior chromosomes is equal to the number of the position chromosomes. When the selecting element 25 cannot find better third superior chromosomes, the evolution of the position chromosomes proceeds until the 800^{th} generation and stops then. The fourth selecting condition is that the dose-rate chromosomes and the varying dose-rate chromosomes corresponding to the first few values of the plurality of fourth adaptation values and fourth varying adaptation values which have smaller numerical values when arranged according to the numerical values are the plurality of fourth superior chromosomes, and the number of the plurality of fourth superior chromosomes is equal to the number of the dose-rate chromosomes. When the selecting element 25 cannot find better fourth superior chromosomes, the evolution of the dose-rate chromosomes proceeds until the 800^{th} generation and stops then.

In addition, mating and mutating the coding chromosomes and the weight chromosomes makes the configuration of the permutation numbers and the weight varying value is various. Through properly mating, mutating and selecting, unsuitable permutation numbers and weight varying values are eliminated and suitable permutation numbers and weight varying values average the weight loaded into each packaging box 40.

It should be noticed that the second embodiment and the first embodiment are different in the consideration of the weight of each packaging box 40. In detail, the genetic algorithm of the first embodiment optimizes the packaging data P according to the permutation number of each dismantled part 10 and the position coordinates and the orientation codes of the voxel model M. In this case, the number of the dismantled parts 10 loaded into the last packaging box 40 might be significantly different from the number of the dismantled parts 10 loaded into any of the other packaging boxes 40. Therefore, in the second embodiment, the first genetic algorithm is proceeded by making use of the permutation number of each dismantled part 10, the second genetic algorithm is proceeded by making use of the weight varying value of each packaging box 40, the third genetic algorithm is proceeded on the position coordinates and orientation codes of each dismantled part 10, and finally the fourth genetic algorithm is proceeded on the dose rate of each dismantled part 10. In this case, the weight loaded into each packaging box 40 is average without the problem happening in the first embodiment.

It should be noted that if there are dismantled parts 10 interfering with each other or exceeding the packaging boxes 40 in the distribution result of the dismantled parts 10 loaded into the packaging boxes 40 in the first embodiment, one may calculate the dose rate of each dismantled part 10 of the first embodiment by optimizing an objective function so as to generate new distribution result of the dismantled parts 10 to prevent each dismantled part 10 from exceeding the packaging boxes or interfering with each other, wherein the optimized objective function is presented as: minf(S)=S_{c}(p′S_{E}+p″S_{I}+φ′″S_{H}); after the distribution result S is evaluated, S_{E} represents the total voxel of the dismantled parts exceeding the packaging boxes, S_{I} represents the total voxel of the dismantled parts interfering with each other, and S_{H} represents the total dose rate of each packaging box 40; φ represents the decision parameter to enable the dose rate to be small or not, φ=1 when the dose rate is taken into consideration, and φ=0 when the dose rate is not taken into consideration; p′ represents the penalty value of spilled voxel amount of the voxel of the dismantled parts exceeding the packaging boxes; p″ represents the penalty value of overlapping voxel amount of the dismantled parts interfering with each other; p′″ represents the weighting of objective function value of dose rate. In both the first embodiment and second embodiment, the total weight and volume of the plurality of dismantled parts 10 are checked for not exceeding the loading capacity of a single bounding box 40.

The foregoing embodiments are illustrative of the efficacy of the method for packaging radioactive dismantled parts of the present invention, and the present invention is not limited to the effects of the foregoing embodiments. The method for packaging radioactive dismantled parts of the present invention also includes other preferred methods for packaging radioactive dismantled parts. The method of packaging radioactive dismantled parts can satisfy the minimal use of the packaging boxes 40 or the dismantling and packaging of the irregular radioactive dismantled parts, which can be part of the method for packaging the radioactive dismantled parts of the present invention.

Further, the calculation of the genetic algorithm of the foregoing embodiments is to communicate and execute the SolidWork software using the MS.NET FrameWork platform and the MS OLE (Object Link and Embedded) and COM (Component Object Model) technologies, wherein SolidWorks provides a complex API (Application Program Interface) library for users to carry out secondary development to support the development of customized computer-aided design functions or to improve design automation. The development of the API was originally designed for the gain function added to the SolidWorks software interface (which will be executed in the same process). The function structure and calling method are not stand-alone applications. Because SolidWorks uses a feature-based parametric modeling model and a data structure for feature stacking, the use of extended functions needs to be in conjunction with the execution of the manual addition of features, component selection, and other manual commands. The packaging method of radioactive dismantled parts of the present invention is developed in a stand-alone mode and is a stand-alone application executed on different programs.

In view of the aforementioned description, the method of packaging radioactive dismantled parts of the invention optimizes the packaging data P through the voxel model M in coordination with the genetic algorithm. Each dismantled part is loaded into the packaging boxes 40. In addition, the weight of each packaging box 40 is taken into consideration. The weight of each packaging box 40 is average and the dismantled parts 10 do not interfere with each other. In summary, the method of packaging dismantled parts of the invention has those advantages described above, optimizes the distribution result of each dismantled part 10 or minimizes the number of the used packaging boxes 40.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Although the terms first, second, third, etc. may be used herein to describe various elements, components, loops, circuits, and/or modules, these elements, components, loops, circuits, and/or modules should not be limited by these terms. These terms may be only used to distinguish one element, component, loop, circuit or module from another element, component, loop, circuit or module. Terms such as “first,” “second,” and other numerical terms when used herein do not imply a sequence or order unless clearly indicated by the context. Thus, a first element, component, loop, circuit or module discussed below could be termed a second element, component, loop, circuit or module without departing from the teachings of the example implementations disclosed herein.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

In this application, apparatus elements described as having particular attributes or performing particular operations are specifically configured to have those particular attributes and perform those particular operations. Specifically, a description of an element to perform an action means that the element is configured to perform the action. The configuration of an element may include programming of the element, such as by encoding instructions on a non-transitory, tangible computer-readable medium associated with the element.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The above description is merely illustrative and not restrictive. Any equivalent modification or change without departing from the spirit and scope of the present disclosure should be included in the appended claims.

What is claimed is:

1. A method of packaging radioactive dismantled parts, comprising:
flipping each dismantled part according to coordinates of the dismantled parts and a packaging condition to produce a bounding body for each dismantled part;
proceeding with voxelization of each bounding body and proceeding discretization of each bounding body into a plurality of cubes, and proceeding with a Boolean algebra process on each cube and the dismantled parts respectively corresponding to each cube such that each cube is divided into a plurality of first cubes and a plurality of second cubes;
proceeding with an analysis of the plurality of first cubes and the plurality of second cubes of each bounding body along an analysis axis such that each of the first cubes and the second cubes has a voxel-line-bunch on each analysis position;
combining each voxel-line-bunch of each bounding body as a voxel model such that each dismantled part respectively corresponds to the voxel model to which each dismantled part belongs, wherein each voxel model has the position coordinates and the orientation codes;
coding each dismantled part such that each dismantled part has a permutation number, and deciding a number of packaging boxes according to the permutation number, wherein each packaging box contains the dismantled parts;
calculating packaging data of each dismantled part contained in each packaging box by a genetic algorithm, comprising:
setting each permutation number as a first corresponding section of a coding chromosome and each first corresponding section respectively having a corresponding permutation number; computing a first adaptation value of each coding chromosome according to the loading capacity, weight and the dose rate limitation of each packaging box;
mating and mutating each coding chromosome to obtain a plurality of varying coding chromosomes, computing a first varying adaptation value of each varying coding chromosome, arranging each first adaptation value and each first varying adaptation value in order, and selecting a plurality of first superior chromosomes according to a first selecting condition;
setting each voxel model corresponding to each first superior chromosome as a second corresponding section of a position chromosome and each second corresponding section respectively having a corresponding voxel model; computing a second adaptation value of each position chromosome according to the position coordinates and the orientation codes of each voxel model;
mating and mutating each position chromosome to obtain a plurality of varying position chromosomes, computing a second varying adaptation value of each varying position chromosome, arranging each second adaptation value and each second varying adaptation value in order, and selecting a plurality of second superior chromosomes according to a second selecting condition; and
integrating the position coordinate, the orientation code and the permutation number corresponding to each second superior chromosome as the packaging data; and
loading each dismantled part into the packaging box, to which each dismantled part belongs, according to the packaging data corresponding to each packaging box.

2. The method of claim 1, wherein the Boolean algebra process is an intersection set operation, each of the first cubes corresponds to the dismantled part to which each of the first cubes belongs, and each of the second cubes does not correspond to the dismantled part to which each of the second cubes belongs.

3. The method of claim 1, wherein the packaging condition is that adjacent surfaces of different dismantled parts are orthogonal.

4. The method of claim 1, wherein the first selecting condition is that the coding chromosomes and the varying coding chromosomes corresponding to the first few values of the plurality of first adaptation values and the first varying adaptation values which have smaller numerical values when arranged according to the numerical values are the plurality of first superior chromosomes, and the number of the plurality of first superior chromosomes is equal to the number of the coding chromosomes.

5. The method of claim 1, wherein the second selecting condition is that the position chromosomes and the varying position chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the position chromosomes.

6. A method of packaging dismantled parts, comprising:
flipping each dismantled part according to coordinates of the dismantled parts and a packaging condition to produce a bounding body for each dismantled part;
proceeding with voxelization of each bounding body and proceeding discretization of each bounding body into a plurality of cubes, and proceeding with a Boolean algebra process on each cube and the dismantled parts respectively corresponding to each cube such that each cube is divided into a plurality of first cubes and a plurality of second cubes;
proceeding with a simulation analysis of the plurality of first cubes and the plurality of second cubes of each bounding body along an analysis axis such that each of the first cubes and the second cubes has a voxel-line-bunch on each analysis position;
combining each voxel-line-bunch of each bounding body as a voxel model such that each dismantled part respectively corresponds to the voxel model to which each dismantled part belongs, wherein each voxel model has the position coordinates and the orientation codes;
coding each dismantled part such that each dismantled part has a permutation number, and deciding a number of packaging boxes according to the permutation number, wherein each packaging box contains the dismantled parts;
calculating permutation data of each dismantled part contained in each packaging box by a genetic algorithm, comprising:
setting each permutation number as a first corresponding section of a coding chromosome and each first corresponding section respectively having a corresponding permutation number; computing a first adaptation value of each coding chromosome according to the loading capacity, weight and the dose rate limitation of each packaging box;
mating and mutating each coding chromosome to obtain a plurality of varying coding chromosomes, computing a first varying adaptation value of each varying coding chromosome, arranging each first adaptation value and each first varying adaptation value in order, and selecting a plurality of first superior chromosomes according to a first selecting condition; and
integrating the permutation number corresponding to each of the first superior chromosomes as the permutation data;
calculating weight data of a weight varying value of each packaging box by a genetic algorithm, comprising:
setting the weight varying value of each packaging box as a second corresponding section of a weight chromosome, each second corresponding section respectively having a corresponding weight varying value, and computing a second adaptation value of each of the weight chromosomes according to each of the weight varying value;
mating and mutating each of the weight chromosomes to obtain a plurality of vary weight chromosome, computing a second varying adaptation value of each of the varying weight chromosome, arranging each second adaptation value and each second varying adaptation value in order, and selecting a plurality of second superior chromosomes according to a second selecting condition; and
integrating the weight varying value corresponding to each second superior chromosome as the weight data;
calculating position data of each dismantled part contained in each packaging box by a genetic algorithm, comprising:
setting each voxel model as a third corresponding section of a position chromosome and each of the third corresponding sections respectively having a corresponding voxel model, computing a third adaptation value of each position chromosome according to the position coordinates and the orientation codes of each voxel model, mating and mutating each position chromosome to obtain a plurality of varying position chromosomes, computing a third varying adaptation value of each varying position chromosome, arranging each of the third adaptation values and each of the third varying adaptation values in order, and selecting a plurality of third superior chromosomes according to a third selecting condition; and
integrating the position coordinates and the orientation codes corresponding to each of the third superior chromosomes as the position data;
calculating dose rate data of each dismantled part contained in each packaging box by a genetic algorithm, including:
setting a dose rate of each dismantled part as a fourth corresponding section of a dose-rate chromosomes, wherein each fourth corresponding section has a corresponding dose rate, calculating a fourth adaptation value of each dose-rate chromosome according to the dose rate of each dismantled part;
mating and mutating each dose-rate chromosome to obtain a plurality of varying dose-rate chromosomes, calculating a fourth varying adaptation value of each varying dose-rate chromosome, arranging each fourth adaptation value and each fourth varying adaptation value in order, and choosing a plurality of fourth superior chromosomes according to a fourth selecting condition; and
integrating the dose rate of each fourth superior chromosome as the dose rate data;
loading each dismantled part into the packaging box, to which each dismantled part belongs, according to the permutation data, the weight data, the position data and the dose rate data corresponding to each packaging box.

7. The method of claim 6, wherein the Boolean algebra process is an intersection set operation, each of the first cubes corresponds to the dismantled part to which each of the first cubes belongs, and each of the second cubes does not correspond to the dismantled part to which each of the second cubes belongs.

8. The method of claim 6, wherein the packaging condition is that adjacent surfaces of different dismantled parts are orthogonal.

9. The method of claim 6, wherein the first selecting condition is that the coding chromosomes and the varying coding chromosomes corresponding to the first few values of the plurality of first adaptation values and the first varying adaptation values which have smaller numerical values when arranged according to the numerical values are the plurality of first superior chromosomes, and the number of the plurality of first superior chromosomes is equal to the number of the coding chromosomes.

10. The method of claim 6, wherein the second selecting condition is that the weight chromosomes and the varying weight chromosomes corresponding to the first few values of the plurality of second adaptation values and second varying adaptation values which have smaller numerical values when arranged according to the numerical values are the plurality of second superior chromosomes, and the number of the plurality of second superior chromosomes is equal to the number of the weight chromosomes.
